(19) United States
(12) Patent Application Publication
(10) Pub. No.: US 2002/0108031 A1
(43) Pub. Date: Aug. 8, 2002

(54) Klyako computer

(76) Inventor: Edin Kljako, Chicago, IL (US)

Correspondence Address: Edin Kljako, 4945 N. Bell Street, Chicago, IL, 60625, US

(21) Appl. No.: 09/777,069

(22) Filed: Feb. 5, 2001

(51) Int. Cl. G06F 15/177; G06F 9/00; G06F 9/24

(52) U.S. Cl. 713/1

(57) ABSTRACT

An apparatus and a method for storing operating system programs on a programmable rom chip(non-erasing), on a motherboard, in a computer. A programmable rom chip, of about 300 megabytes in size, enough to hold a large operating system, is installed on the motherboard, in addition to the system bios. The addition of of the programmable rom chip is to hold the bios of the computer and the operating system(windows type system or another disk operating system) while a hard disk is used to store only applications programs and files. The operating system would be pre-loaded with upgradeability made possible by a program developed for the newly designed computer.

### CROSS REFERENCE

U.S. Pat. No. 5,479,639 December., 1995 Ewertz, et al.

I am not claiming that this invention arose from the above invention. I am, however,claiming that my invention is very similar to the above outdated invention and should be classified accordingly. We work with operating systems that are from 10 to 200 megabytes in length. I am using ideas similar, but not exact, as the above application for a full sized computer.

### FEDERALLY SPONSORED RESEARCH

Not applicable

### REFERENCE TO MICROFICHE APPENDIX

Not applicable

### BACKGROUND OF THE INVENTION

This invention pertains generally to computer systems, in particular, a computer that employs the use of a programmable rom chip(flash card, eprom or something similar), of 300 megabytes or more, to store system files and programs, resulting in the elimination of a wait period for the loading of an operating system.

This invention is an improvement to “bios” that other computer manufacturers incorporate in their system architectures. Not only does the programmable rom chip carry the system bios(files on a programmable rom chip that control peripheral operations, but rather, the operating system is stored on the programmable rom chip as well.

Computer systems generally use a hard disk to store operating system files and programs. Files and programs for external peripherals are stored in system bios. In order for a person to start his computer, he would have to wait for the operating system to load itself into memory. The time period required to load these programs into ram is usually a few seconds and more, depending on the age of the computer.

The present invention places the system and program files necessary to operate the computer in the programmable memory chip; it also stores the operating system(windows or dos) on the same chip. The bios would have to be accessed once, at the factory. This eliminates the time required to load programs and files into ram. It employs a programmable rom chip to store the operating system and support files. These files would be constantly in memory. The only thing that the user would be required to do is turn on the monitor and call up the program that he wishes to use.

### BRIEF SUMMARY OF THE INVENTION

It is the object of this invention to provide a computer with a programmable memory chip that would hold an operating system's files and programs, eliminating the time required to load a large operating system. This computer system would allow the emergence of a first disk(programmable rom chip) and a second disk(hard disk) for storing files and programs not associated with the operating system.

This invention makes the personal computer or notebook computer “always on,” much like the personal digital assistant or calculator. This embellishes the general computer design and operation. It is very similar to a personal digital assistant or calculator design, however, this is a larger desktop or laptop computer.

### BRIEF DESCRIPTION OF THE SEVERAL VIEWS OF THE DRAWING

Not applicable

### DESCRIPTION OF THE PREFERRED EMBODIMENT

The KLYAKO COMPUTER employs a programmable rom chip on the mother board. The rom chip is an embellishment on computer architecture that makes everyday starting and shutting down a computer much quicker and easier. This chip will be used to the store an entire operating system and programs and files that control peripheral operations(bios). This eliminates a wait time required for an operating system to load into ram. This also eliminates the wait time required for a system to shut down. What we have done is made a computer that is on all the time and shuts down as easy as it starts.

When installing a new peripheral, internal or external, the information in the rom chip would be upgraded by a special program developed for the new architecture. In other words, the rom chip would be manipulated by an operating system program to allow the addition of a new peripheral or the addition of an improvement to an existing program. In order to remove a peripheral from memory, the same program would be used.

What is claimed is:

1. A programmable rom chip is installed on a motherboard. This chip is to contain not only the bios of the computer, but the operating system(windows type) as well. This eliminates the time required for loading an operating system, thus speeding things up for an end user.

2. Storing operating system files on a programmable rom chip, permanently affixed to the motherboard, eliminating the time necessary for loading an operating system and the time necessary for shut down of the system. This allows a computer manufacturer to store an entire operating system(a dos or more probably a windows type of system) on a non-erasable chip.

3. Storing system files that control peripherals, resources such as disk drive, printer, monitor, and etc.)on a programable rom chip(an expansion of the bios chip) In all practicality, a windows based system would be loaded into the rom chip. The system would be loaded once in the factory, thereby initiating the system bios one time in the life of the computer(excluding errors or viruses which would require the computer to be re-started).

4. Hard disk drive would be used only for storing files and programs(files and programs not related to the system's files or programs). The hard disk would only be used to store applications programs and files(database programs, spreadsheets, word processing programs, etc.), and user files.
